(19) United States
(12) Patent Application Publication
(10) Pub. No.: US 2025/0206299 A1
(43) Pub. Date: Jun. 26, 2025

(54) DRIVING ASSISTANCE DEVICE, DRIVING ASSISTANCE METHOD, AND STORAGE MEDIUM

(71) Applicant: HONDA MOTOR CO., LTD., Tokyo (JP)

(72) Inventor: Taku YAMAZAKI, Tokyo (JP)

(21) Appl. No.: 18/975,311

(22) Filed: Dec. 10, 2024

(30) Foreign Application Priority Data
Dec. 26, 2023 (JP) 2023-219944

(51) Int. Cl. B60W 30/095; B60W 50/00; B60W 50/14; H04W 4/46

(52) U.S. Cl. CPC B60W 30/0956; B60W 50/0097; B60W 50/14; H04W 4/46; B60W 2520/10; B60W 2554/4041; B60W 2554/4042; B60W 2554/4045; B60W 2554/801; B60W 2556/65

(57) ABSTRACT

A driving assistance device is configured to acquire peripheral vehicle information of a peripheral vehicle existing around a self-vehicle, predict a possibility of collision between the self-vehicle and the peripheral vehicle based on self-vehicle information and the peripheral vehicle information, and notify an occupant of the self-vehicle based on a prediction result. The device predicts a possibility of collision between the self-vehicle and the peripheral vehicle based on at least the indication state of the blinker of the self-vehicle, the indication state of the blinker of the peripheral vehicle, and the position of the peripheral vehicle with respect to the self-vehicle.

### CROSS-REFERENCE TO RELATED APPLICATION(S)

This application claims priority to and the benefit of Japanese Patent Application No. 2023-219944, filed Dec. 26, 2023, the entire disclosure of which is incorporated herein by reference.

### BACKGROUND OF THE INVENTION

### Field of the Invention

The present invention relates to a driving assistance device, a driving assistance method, and a storage medium.

### Description of the Related Art

In recent years, efforts to provide access to sustainable transportation systems in consideration of vulnerable road users among traffic participants have been gaining momentum. In order to realize this, research and development for further improving traffic safety and convenience is focused on research and development related to preventive safety techniques. There is known a device that performs driving assistance for preventing a collision with another vehicle (peripheral vehicle) or the like. Japanese Patent Laid-Open No. 2020-16950 describes determining whether or not a current state is a dangerous state based on a state of a direction indicator of another vehicle. Japanese Patent No. 7274991 describes determining whether a preceding vehicle changes lanes or changes course based on a state of a blinker. Japanese Patent Laid-Open No. 2013-134567 describes determining whether or not there is a possibility of collision between a self-vehicle and another vehicle based on whether the self-vehicle turns right or turns left. International Publication No. 2015/008380 describes suppressing collision avoidance assistance according to a steering situation by a driver of a vehicle. It is difficult to accurately acquire a blinker indication state of another vehicle by a sensor such as a camera.

### SUMMARY OF THE INVENTION

According to some aspects of the present disclosure, an advantageous technique for appropriately performing driving assistance of a self-vehicle is provided. Accordingly, the present disclosure contributes to development of a sustainable transportation system. According to some embodiments, a driving assistance device comprising: an acquisition unit configured to acquire peripheral vehicle information indicating a vehicle speed, a position, a traveling track, and an indication state of a blinker of a peripheral vehicle existing around a self-vehicle mounted with the driving assistance device from the peripheral vehicle by vehicle-to-vehicle communication; a prediction unit configured to predict a possibility of collision between the self-vehicle and the peripheral vehicle based on self-vehicle information indicating a vehicle speed, a position, a traveling track, and an indication state of a blinker of the self-vehicle and the peripheral vehicle information; and a notification unit configured to notify an occupant of the self-vehicle based on a prediction result by the prediction unit, wherein the prediction unit predicts a possibility of collision between the self-vehicle and the peripheral vehicle based on at least the indication state of the blinker of the self-vehicle, the indication state of the blinker of the peripheral vehicle, and the position of the peripheral vehicle with respect to the self-vehicle is provided.

### BRIEF DESCRIPTION OF THE DRAWINGS

FIG. 1 is a block diagram for describing a configuration example of a vehicle according to some embodiments;

FIG. 2 is a diagram for describing an example of risk position information according to some embodiments;

FIGS. 3A and 3B are schematic diagrams for describing an example of a track intersection according to some embodiments;

FIG. 4 is a flowchart for describing an example of a method of registering a peripheral vehicle according to some embodiments;

FIG. 5 is a schematic diagram for describing an example of a range including a peripheral vehicle according to some embodiments;

FIG. 6 is a flowchart for describing an example of a driving assistance operation related to a peripheral vehicle located on the side according to some embodiments;

FIGS. 7A and 7B are schematic diagrams for describing an example of a driving assistance operation related to a peripheral vehicle located on the side according to some embodiments;

FIG. 8 is a schematic diagram for describing an example of a driving assistance operation related to a peripheral vehicle located on the side according to some embodiments;

FIGS. 9A and 9B are schematic diagrams for describing an example of a driving assistance operation related to a peripheral vehicle located on the side according to some embodiments;

FIG. 10 is a flowchart for describing an example of a driving assistance operation related to a peripheral vehicle located ahead according to some embodiments;

FIG. 11 is a schematic diagram for describing an example of a driving assistance operation related to a peripheral vehicle located ahead according to some embodiments;

FIG. 12 is a schematic diagram for describing an example of a driving assistance operation related to a peripheral vehicle located ahead according to some embodiments; and

FIG. 13 is a schematic diagram for describing an example of a method of determining a peripheral vehicle to be determined according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Vehicle Configuration Example

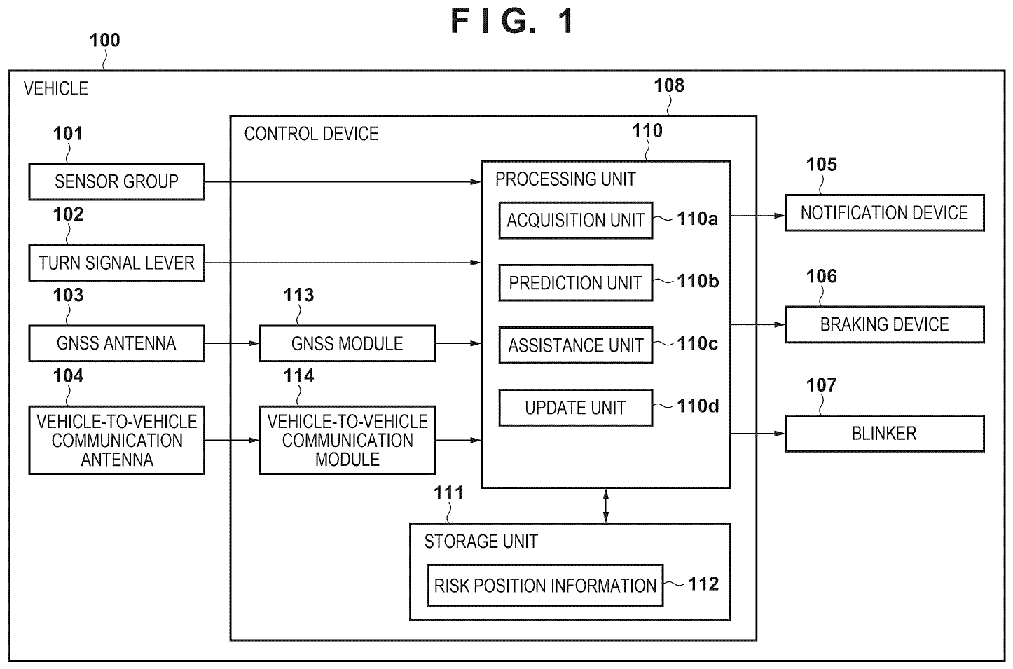

A configuration example of a vehicle 100 according to some embodiments will be described with reference to FIG. 1. As illustrated in FIG. 1, the vehicle 100 may include a sensor group 101, a turn signal lever 102, a global navigation satellite system (GNSS) antenna 103, a vehicle-to-vehicle communication antenna 104, a notification device 105, a braking device 106, a blinker 107, and a control device 108. Although FIG. 1 illustrates components referred to in the following description, the vehicle 100 may include other components for operating as a vehicle, such as a driving device and a transmission. Additionally or alternatively, the vehicle 100 may not include some of the components illustrated in FIG. 1. The vehicle 100 may be a four-wheeled vehicle, a two-wheeled vehicle, or another type of vehicle. Hereinafter, a driver of the vehicle 100 may be simply referred to as a driver.

The control device 108 controls the overall operation of the vehicle 100. As described later, the control device 108 performs driving assistance of the vehicle 100 on which the control device 108 is mounted. Therefore, the control device 108 may be referred to as a driving assistance device. The driving assistance provided by the control device 108 may be collision prevention assistance for preventing (reducing) a collision with another vehicle. In some embodiments, the control device 108 is capable of performing the collision prevention assistance without using map information. In the following description, the vehicle 100 may be referred to as a self-vehicle 100 to facilitate distinction from other vehicles. In addition, a vehicle different from the vehicle 100 may be referred to as another vehicle. Among other vehicles, a vehicle that currently exists around the self-vehicle 100 may be referred to as a peripheral vehicle. The peripheral vehicle may be a vehicle that can currently perform vehicle-to-vehicle communication with the self-vehicle 100.

The sensor group 101 includes various sensors for performing the driving assistance of the vehicle 100. For example, the sensor group 101 can include a speed sensor that detects the speed of the vehicle 100, an acceleration sensor that detects the acceleration of the vehicle 100, and the like. In addition, the sensor group 101 may include an outside detection sensor such as a camera capable of detecting an object around the vehicle 100, a millimeter wave radar, or a light detection and ranging (LIDAR). The sensor group 101 outputs the detection result to the control device 108.

The turn signal lever 102 is an operator for receiving an operation of changing an indication state of the blinker 107 (which may also be referred to as a direction indicator) from the driver. The indication state of the blinker 107 may include a state of indicating the right side of the vehicle 100, a state of indicating the left side of the vehicle 100, and a state of not indicating any side. The control device 108 switches the indication state of the blinker 107 in accordance with the operation of the turn signal lever 102 by the driver. The blinker 107 may be located on both the right and left sides of the vehicle 100. For example, when the driver operates the turn signal lever 102 to indicate the right side, the control device 108 causes the blinker 107 on the right side of the vehicle 100 to blink. When the driver operates the turn signal lever 102 to indicate the left side, the control device 108 causes the blinker 107 on the left side of the vehicle 100 to blink. When the driver operates the turn signal lever 102 so as not to indicate any direction, the control device 108 turns off the blinkers 107 on both sides of the vehicle 100. The control device 108 may change the indication state of the blinker 107 without depending on the operation of the turn signal lever 102 by the driver. For example, the control device 108 may turn off the blinking blinker 107 in response to the end of turning of the vehicle 100.

The GNSS antenna 103 receives a radio wave for location measurement transmitted from a GNSS satellite. For example, the GNSS antenna 103 can be used to acquire information regarding the current position and/or the traveling track (traveling history) of the vehicle 100. The vehicle-to-vehicle communication antenna 104 is an antenna that transmits and receives various types of data to and from peripheral vehicles. For example, the vehicle-to-vehicle communication antenna 104 can be used to acquire information regarding the current position, speed, and traveling track of a peripheral vehicle.

The notification device 105 is a device that notifies an occupant (for example, a driver) of the vehicle 100. In a case where the vehicle 100 may collide with a peripheral vehicle, the control device 108 can notify the occupant of the vehicle 100 of the possibility of collision with the peripheral vehicle by the notification device 105 as driving assistance. For example, the notification device 105 may include a display unit, such as a display, and display information indicating a possibility of collision with a peripheral vehicle on the display unit, or may include a sound output unit, such as a speaker, and output information indicating a possibility of collision with a peripheral vehicle from the sound output unit by sound or the like.

The braking device 106 is a device, such as a brake, for performing a braking operation of the vehicle 100. In a case where the vehicle 100 may collide with a peripheral vehicle, as driving assistance, the control device 108 can perform deceleration assistance of the vehicle 100 by operating the braking device 106, thereby avoiding a collision with the peripheral vehicle.

The control device 108 is a device (computer) that controls the vehicle 100, and can include, for example, an electric control unit (ECU). The control device 108 can perform driving assistance by vehicle-to-vehicle communication with another vehicle and processing in the vehicle 100. For example, the control device 108 can perform driving assistance without using map information. The control device 108 includes a processing unit 110, a storage unit 111, a GNSS module 113, and a vehicle-to-vehicle communication module 114, which are connected to each other by a bus (not illustrated).

The processing unit 110 is a processor represented by a central processing unit (CPU), and executes a program stored in the storage unit 111. The storage unit 111 includes, for example, a random access memory (RAM), a read only memory (ROM), a hard disk, and the like, and stores a program (driving assistance program) for the processing unit 110 to perform driving assistance processing of the vehicle 100, a program (learning program) for the processing unit 110 to learn a risk position, various data, and the like. The storage unit 111 may store risk position information 112 created based on an intersection of a traveling track of the vehicle 100 and a traveling track of another vehicle. The risk position information 112 may include a plurality of risk positions. The risk position may be a position where the vehicle 100 may collide with another vehicle or a position where the possibility of collision is high. The risk position information 112 may be managed as a database.

The GNSS module 113 receives position information and the like of the vehicle 100 from the GNSS satellite via the GNSS antenna 103. In addition, the vehicle-to-vehicle communication module 114 receives various types of information from another vehicle via the vehicle-to-vehicle communication antenna 104.

The processing unit 110 can include an acquisition unit 110a, a prediction unit 110b, an assistance unit 110c, and an update unit 110d to perform driving assistance (collision prevention assistance in some embodiments) of the vehicle 100. Note that the processing unit 110 is not limited to the configuration including the units 110a to 110d. Another unit may be added or some units may be omitted depending on the type of driving assistance performed by the vehicle 100.

The acquisition unit 110a acquires peripheral vehicle information indicating a current position, a vehicle speed, a traveling track, and a blinker indication state of a peripheral vehicle that exists around the vehicle 100 from the peripheral vehicle via the vehicle-to-vehicle communication antenna 104 (vehicle-to-vehicle communication module 114). The peripheral vehicle information may explicitly or implicitly represent the current position, the vehicle speed, the traveling track, and the indication state of the blinker of the peripheral vehicle. For example, the peripheral vehicle information may include the vehicle speed as it is, or may include information for calculating the vehicle speed (two current and previous geographical positions and their positioning times). The acquisition unit 110a may acquire self-vehicle information indicating a current position, a vehicle speed, a traveling track, and an indication state of the blinker 107 of the vehicle 100 via the sensor group 101 and the GNSS antenna 103 (GNSS module 113). The acquisition unit 110a may acquire the indication state of the blinker 107 from the blinker 107, or may store the latest change command to the blinker 107 and acquire the indication state based on the stored change command.

The prediction unit 110b predicts a possibility that the vehicle 100 collides with another vehicle based on the self-vehicle information and the peripheral vehicle information acquired by the acquisition unit 110a. The prediction unit 110b may set a determination region and predict a possibility that the vehicle 100 collides with another vehicle in the determination region. In addition, the prediction unit 110b may perform driving assistance of the vehicle 100 based on the risk position information 112. For example, in a case where at least one risk position among a plurality of risk positions included in the risk position information 112 is located near the self-vehicle, the prediction unit 110b may set the determination region so as to include the risk position.

The assistance unit 110c performs driving assistance (collision prevention assistance) for the self-vehicle 100 based on a prediction result by the prediction unit 110b. In some embodiments, the assistance unit 110c can perform, as driving assistance of the vehicle 100, at least one of notification to an occupant of the vehicle 100 by the notification device 105 and deceleration assistance of the vehicle 100 by the braking device 106. The deceleration assistance may include assisting to decelerate until the self-vehicle 100 stops, that is, a stop assistance. The stop assistance may include not only deceleration of the self-vehicle 100 but also determination of a stop position of the self-vehicle 100, a route plan for the stop position, and automatic steering along the route.

The update unit 110d identifies an intersection of a traveling track of the vehicle 100 and a traveling track of the peripheral vehicle. The intersection of the traveling track of the vehicle 100 and the traveling track of the peripheral vehicle is hereinafter referred to as a track intersection. There may be a road intersection near the track intersection. In addition, the update unit 110d updates the risk position information 112 stored in the storage unit 111 based on the identified track intersection. For example, the update unit 110d may update the risk position information 112 by adding the track intersection to the risk position information 112. Alternatively or additionally, the update unit 110d may update the risk position information 112 by correcting any risk position included in the risk position information 112 based on the track intersection.

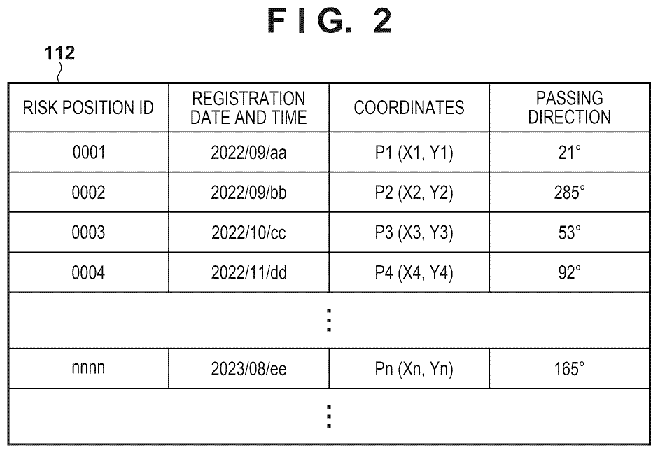

Subsequently, an example of the risk position information 112 will be described with reference to FIG. 2. In the example of FIG. 2, the risk position information 112 is described in a table format, but the risk position information 112 may be described in another format. The risk position information 112 has a record for each risk position. The column of the risk position information 112 illustrated in FIG. 2 is an example. The risk position information 112 may include other columns or may not include a part of the columns illustrated in FIG. 2.

The risk position information 112 may include information regarding a risk position ID, a registration date and time, coordinates, and a passing direction for each risk position. The risk position ID is a number for uniquely identifying the risk position. The registration date and time is a date and time when the risk position is registered in the risk position information 112. The coordinates are data for identifying the risk position, and are represented by, for example, latitude and longitude data. In addition to the latitude and longitude data, the coordinates may include altitude data such as elevation. The passing direction is a direction (direction, angle) in which the vehicle 100 faces when passing through the track intersection used to determine the risk position. The passing direction may be understood as a traveling direction (entering direction) of the vehicle 100 when entering the track intersection. In the example of FIG. 2, the passing direction of the vehicle 100 is prescribed with the north direction as 0°, the east direction as 90°, the south direction as 180°, and the west direction as 270°.

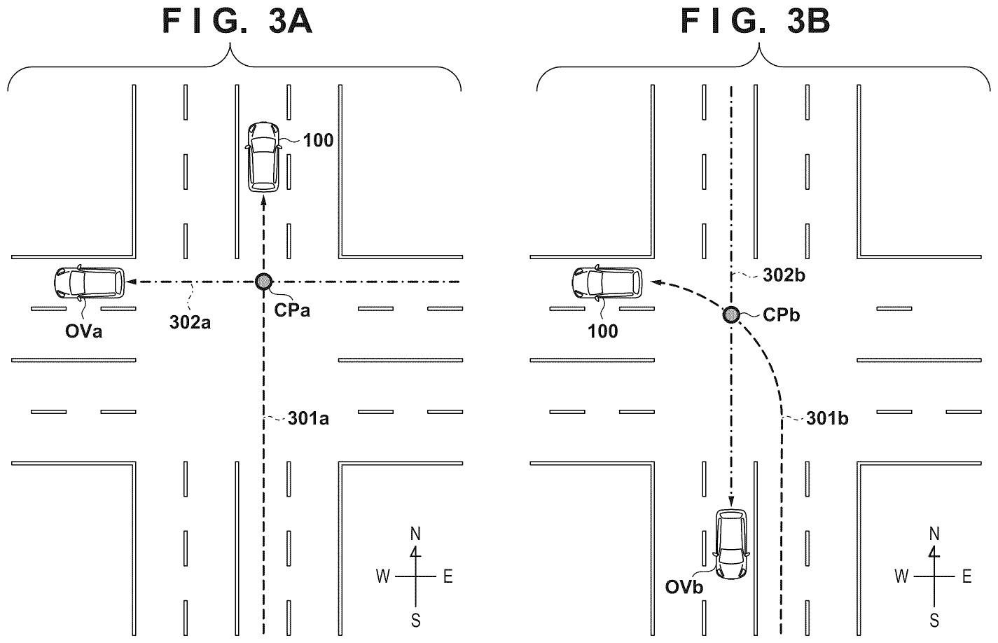

Subsequently, an example of the track intersection will be described with reference to FIGS. 3A and 3B. As described above, the track intersection is an intersection of a traveling track of the vehicle 100 and a traveling track of another vehicle. In the present specification, a case will be described in which the vehicle 100 is located in a region where right-hand traffic is mandatory. In this case, out of the left side and the right side, the side of a road on which passage is mandatory in the region where the vehicle 100 is located is the right side, and the opposite side is the left side. The opposite lane side of the vehicle 100 is the left side of the vehicle 100. The embodiment described in the present specification is also applicable to a case in which the vehicle 100 is located in a region where left-hand traffic is mandatory. In this case, the left and right sides (for example, a right turn and a left turn of the vehicle 100 or another vehicle, and a right side and a left side of a blinker indication state) in the processing described below are interchanged. Specifically, out of the left side and the right side, the side of the road on which passage is mandatory in the region where the vehicle 100 is located is the left side, and the opposite side is the right side. The opposite lane side of the vehicle 100 is the right side of the vehicle 100.

In the example illustrated in FIG. 3A, a position where a traveling track 301a of the self-vehicle 100 traveling straight in the north direction and a traveling track 302a of another vehicle OVa traveling straight in the west direction intersect is a track intersection CPa. Since timing (time) at which the self-vehicle 100 passes through the track intersection CPa and timing (time) at which another vehicle OVa passes through the track intersection CPa are different from each other, no collision occurs between the self-vehicle 100 and another vehicle OVa. In addition, the traveling track 301a of the self-vehicle 100 is included in the self-vehicle information acquired by the acquisition unit 110a via the sensor group 101 and the GNSS antenna 103 (GNSS module 113). The traveling track 302a of another vehicle OVa is included in another vehicle information acquired by the acquisition unit 110a via the vehicle-to-vehicle communication antenna 104 (vehicle-to-vehicle communication module 114). Since another vehicle OVa at the time of the acquisition is a peripheral vehicle that exists around the self-vehicle 100, another vehicle information may be understood as peripheral vehicle information.

In the example illustrated in FIG. 3B, a position where a traveling track 301b of the self-vehicle 100 traveling straight in the north direction and turning left, and a traveling track 302b of another vehicle OVb traveling straight in the south direction intersect is a track intersection CPb. Note that, since timing (time) at which the self-vehicle 100 passes through the track intersection CPb and timing (time) at which another vehicle OVb passes through the track intersection CPb are different from each other, no collision occurs between the self-vehicle 100 and another vehicle OVb. In addition, similarly to the traveling track 301a, the traveling track 301b of the self-vehicle 100 is included in the self-vehicle information acquired by the acquisition unit 110a via the sensor group 101 and the GNSS antenna 103 (GNSS module 113). Similarly to the traveling track 302a, the traveling track 302b of another vehicle OVb is included in another vehicle information (peripheral vehicle information) acquired by the acquisition unit 110a via the vehicle-to-vehicle communication antenna 104 (vehicle-to-vehicle communication module 114).

The function of the control device 108 can be realized by both hardware and software. For example, the function of the control device 108 may be realized by the processing unit 110 (CPU) performing the driving assistance program and/or the learning program as described above, or may be realized by an integrated circuit such as a programmable logic device (PLD) or an application specific integrated circuit (ASIC). In addition, in the example of FIG. 1, although the control device 108 is illustrated as a single element, the control device 108 may be divided into two or more elements as necessary.

### Management Processing of Peripheral Vehicle

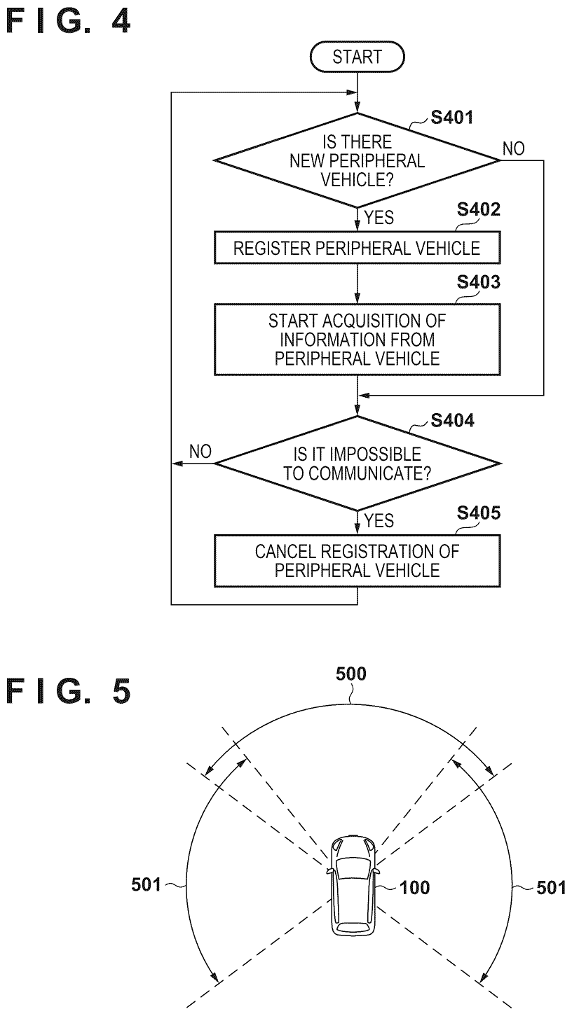

An example of processing of managing the peripheral vehicle will be described with reference to FIG. 4. The processing illustrated in the flowchart of FIG. 4 is performed by the processing unit 110 according to the learning program read from the storage unit 111. The processing in FIG. 4 may be started, for example, in response to the ignition of the vehicle 100 being turned on. The processing in FIG. 4 can be repeatedly performed until the ignition of the vehicle 100 is turned off.

In step S401, the processing unit 110 (for example, the acquisition unit 110a thereof) determines whether or not another vehicle exists around the self-vehicle 100. In a case where it is determined that another vehicle exists around the self-vehicle 100, the processing unit 110 shifts the processing to step S402, and shifts the processing to step S404 in other cases. For example, in a case where vehicle-to-vehicle communication can be performed via the vehicle-to-vehicle communication antenna 104 (vehicle-to-vehicle communication module 114), the processing unit 110 may determine that another vehicle exists around the self-vehicle 100.

In step S402, the processing unit 110 (for example, the acquisition unit 110a thereof) registers another vehicle found in step S401 as the peripheral vehicle. For example, the storage unit 111 may store a list of peripheral vehicles, and the processing unit 110 may add information of the found peripheral vehicle to this list. As will be described later, the peripheral vehicle is a target of a determination as to the possibility of collision. Instead of managing information of peripheral vehicles in a list, information may be acquired from all other vehicles capable of vehicle-to-vehicle communication at the start of each cycle in processing that is repeatedly executed, and the information acquired in this cycle may be discarded at the end of each cycle.

In step S403, the processing unit 110 (for example, the acquisition unit 110a thereof) starts acquisition of peripheral vehicle information from the peripheral vehicle by the vehicle-to-vehicle communication. As described above, the peripheral vehicle information may represent the vehicle speed, the position, and the traveling track of the peripheral vehicle. After starting the acquisition of the peripheral vehicle information in step S403, the processing unit 110 periodically (for example, every 100 ms) repeatedly acquires the peripheral vehicle information until the vehicle-to-vehicle communication with the peripheral vehicle can no longer be performed.

After the start of the acquisition of the peripheral vehicle information, in step S404, the processing unit 110 (for example, the acquisition unit 110a thereof) determines whether or not a vehicle that cannot perform the vehicle-to-vehicle communication exists among one or more registered peripheral vehicles. In a case where such a vehicle exists, the processing unit 110 shifts the processing to step S405, and shifts the processing to step S401 in other cases. For example, in a case where the peripheral vehicle is out of a communication range of the vehicle-to-vehicle communication or a power supply of the peripheral vehicle is turned off, the vehicle 100 cannot perform the vehicle-to-vehicle communication with the peripheral vehicle.

In step S405, the processing unit 110 (for example, the acquisition unit 110a thereof) cancels the registration of the peripheral vehicle that cannot perform the vehicle-to-vehicle communication. In other words, the processing unit 110 does not treat the vehicle that cannot perform the vehicle-to-vehicle communication as the peripheral vehicle. For example, the processing unit 110 deletes, from the list of peripheral vehicles stored in the storage unit 111, information regarding the peripheral vehicle that cannot perform the vehicle-to-vehicle communication.

As described above, by performing the processing of FIG. 4, the processing unit 110 can periodically acquire the latest peripheral vehicle information from another vehicle (that is, the peripheral vehicle) around the self-vehicle 100.

### Driving Assistance Processing

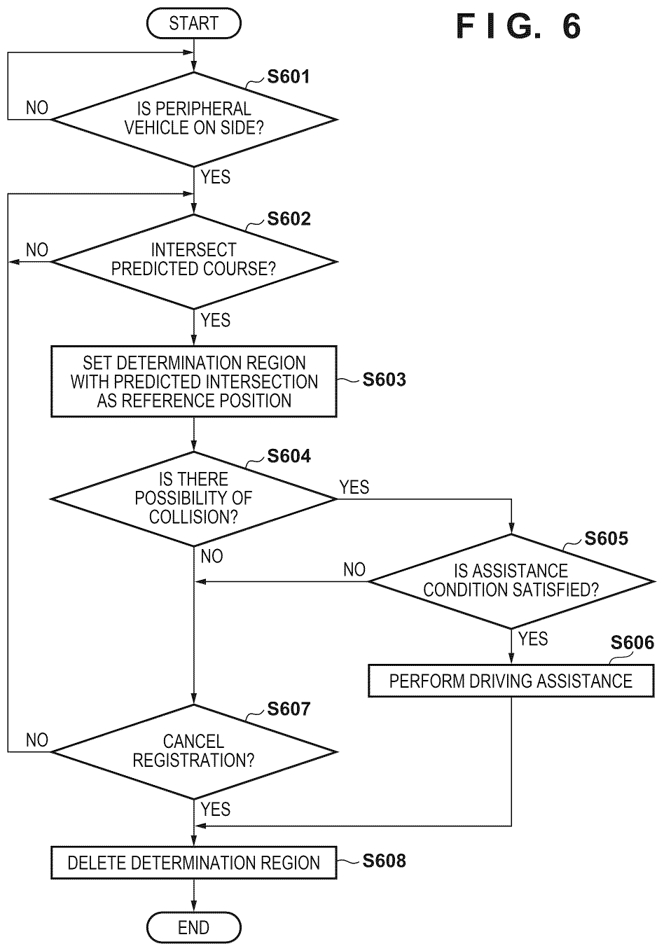

Driving assistance processing of some embodiments will be described with reference to FIGS. 5 to 13. As described with reference to FIG. 3A, when both the self-vehicle 100 and another vehicle travel straight in a case where another vehicle is included in the range on the side of the self-vehicle 100, these vehicles may collide with each other. On the other hand, as described with reference to FIG. 3B, when the self-vehicle 100 turns left and another vehicle travels straight in a case where another vehicle is included in the range ahead of the self-vehicle 100, these vehicles may collide with each other. As described above, depending on the position of another vehicle with respect to the self-vehicle 100, the situation where these vehicles may collide with each other can vary. Therefore, in some embodiments, the control device 108 performs separate driving assistance according to whether a peripheral vehicle exists within the range ahead of the self-vehicle 100 or within the range on the side of the self-vehicle 100.

A range for selecting a driving assistance method will be described with reference to FIG. 5. A range 500 is located ahead of the vehicle 100. The ahead of the vehicle 100 may be a range including the front of the vehicle 100. As illustrated in FIG. 5, the range 500 may be a fan-shaped range or may have another shape. The fan-shaped range may be defined by a predetermined distance and a predetermined angle. The predetermined distance may be, for example, 800 m or more and 1000 m or less, for example, 900 m. The same applies to the predetermined distance in the following fan-shaped range. The range 500 may be symmetrical with respect to the direction of the front of the vehicle 100. A central angle of the range 500 may be, for example, about 100 degrees to 110 degrees.

A range 501 is located on the side of the vehicle 100. The side of the vehicle 100 may be a range including the oblique front of the vehicle 100. The range 501 may include the direction just beside the vehicle 100. As illustrated in FIG. 5, the range 501 may be a fan-shaped range or may have another shape. The fan-shaped range may be defined by a predetermined distance and a predetermined angle. In the example of FIG. 5, the range 501 is located on each of the right side and the left side of the vehicle 100. A central angle of the range 501 may be, for example, about 80 degrees to 90 degrees.

In the example of FIG. 5, a part of the range 500 and a part of the range 501 overlap. The central angle of the overlapped part may be, for example, about 10 to 20 degrees. In a case where a peripheral vehicle exists in the overlapped part, the peripheral vehicle is subjected to both driving assistance under the situation of FIG. 3A and driving assistance under the situation of FIG. 3B. Instead of the example of FIG. 5, the range 500 and the range 501 may be only in contact with each other or may be separated from each other. The range 500, the range 501 on the right side of the vehicle 100, and the range 501 on the left side of the vehicle 100 may have the same size, or at least a part thereof may have different sizes.

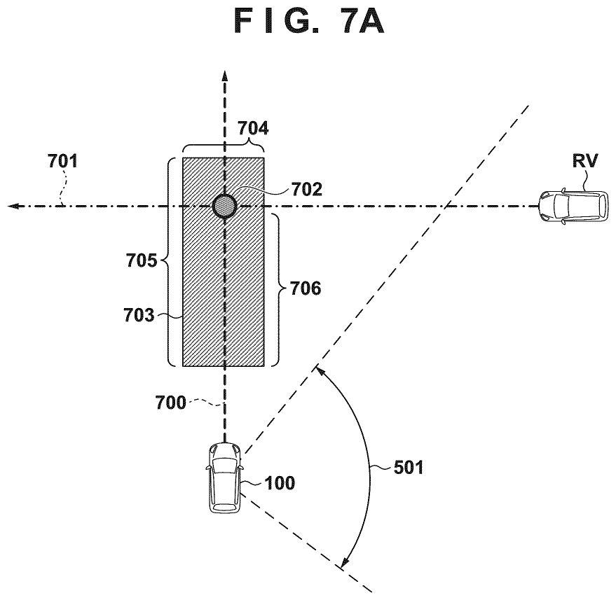

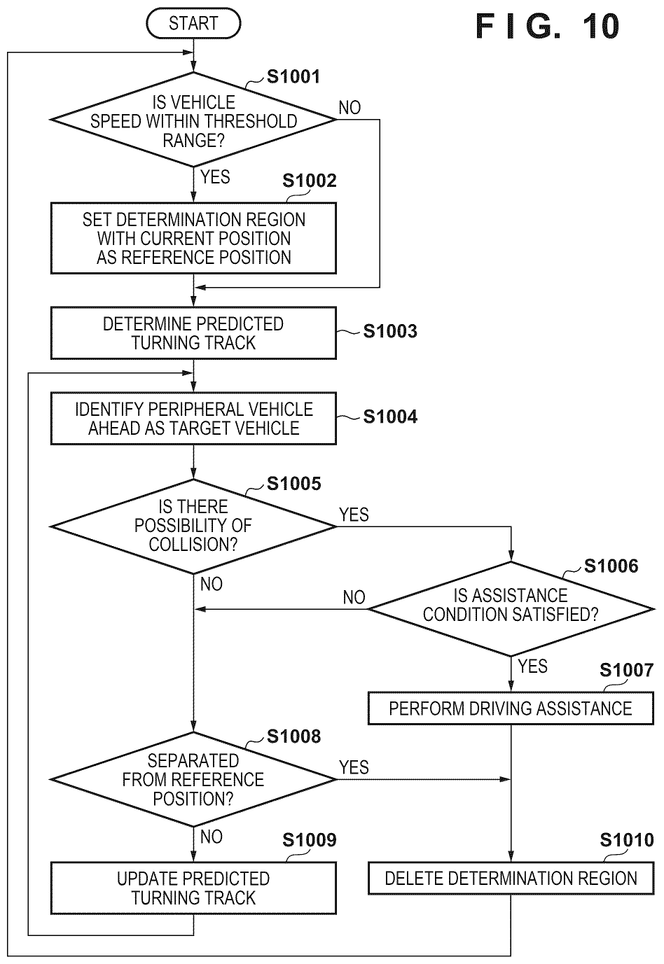

In a case where the peripheral vehicle is included in the range 501, as illustrated in FIG. 3A, the self-vehicle 100 can collide with another vehicle by traveling straight. Therefore, the control device 108 predicts the possibility of collision due to the self-vehicle 100 traveling straight. This operation will be described later with reference to FIGS. 6 to 9B. Meanwhile, in a case where the peripheral vehicle is included in the range 500, as illustrated in FIG. 3B, the self-vehicle 100 can collide with another vehicle by turning left. Therefore, the control device 108 predicts the possibility of collision due to the self-vehicle 100 traveling straight. This operation will be described later with reference to FIGS. 10 to 12. The positions of the ranges 500 and 501 with respect to the self-vehicle 100 may be set in advance (for example, at the time of manufacturing the vehicle 100 or at the time of updating the software) and stored in the storage unit 111.

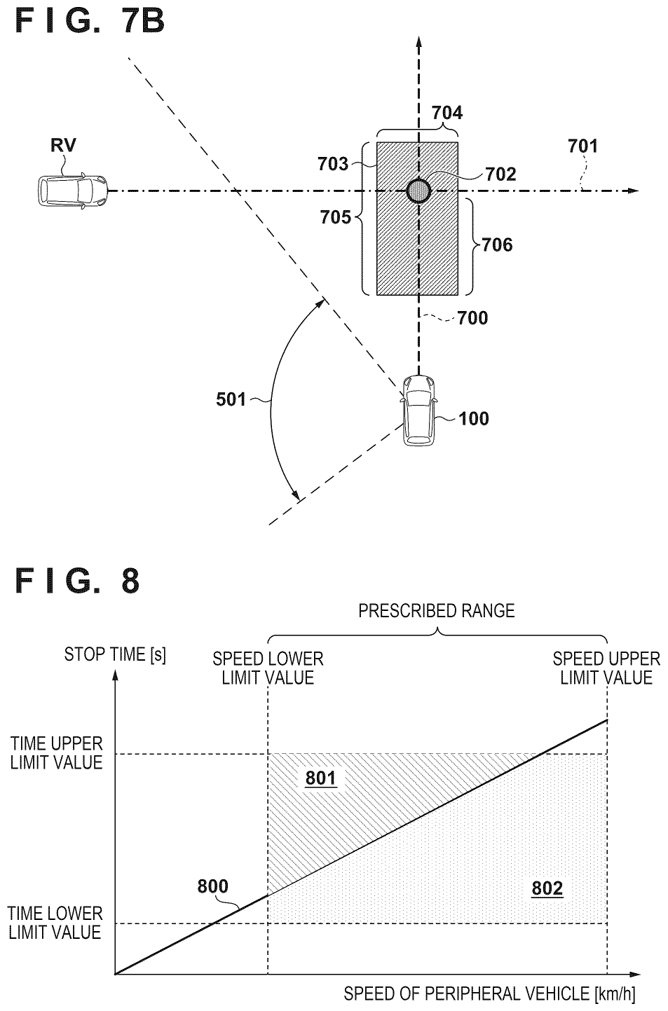

FIG. 6 illustrates an example of processing for performing driving assistance in a case where a peripheral vehicle RV (FIG. 7A) exists within the range 501 on the side of the self-vehicle 100. The processing illustrated in the flowchart of FIG. 6 is performed by the processing unit 110 according to the driving assistance program read from the storage unit 111. Every time the peripheral vehicle RV is newly registered in step S602 of FIG. 6 while the driving assistance setting is turned on, for example, the processing in FIG. 6 may be performed for the peripheral vehicle RV. In the processing in FIG. 6, a plurality of other vehicles can be registered as peripheral vehicles. The processing in FIG. 6 is performed for each of the plurality of peripheral vehicles.

In step S601, the processing unit 110 (for example, the prediction unit 110b thereof) determines whether or not the peripheral vehicle RV exists within the range 501 on the side of the self-vehicle 100. In a case where it is determined that the peripheral vehicle RV exists within the range 501 on the side of the self-vehicle 100, the processing unit 110 shifts the processing to step S602, and repeats step S601 in other cases. This determination may be made based on the current position of the peripheral vehicle RV included in the latest peripheral vehicle information acquired from the peripheral vehicle RV. In the example illustrated in FIG. 7A, the peripheral vehicle RV exists within the range 501.

In step S602, the processing unit 110 (for example, the prediction unit 110b thereof) determines whether or not the predicted course of the self-vehicle 100 and the predicted course of the peripheral vehicle RV intersect. In a case where it is determined that these predicted courses of both the vehicles intersect, the processing unit 110 shifts the processing to step S603, and repeats step S602 in other cases. The predicted course may be a half line extending forward from a vehicle. In the example illustrated in FIG. 7A, a predicted course 700 of the self-vehicle 100 and a predicted course 701 of the peripheral vehicle RV intersect. An intersection of the predicted course 700 of the self-vehicle 100 and the predicted course 701 of the peripheral vehicle RV is referred to as a predicted intersection 702. The predicted course 700 of the self-vehicle 100 may be determined based on the self-vehicle information (specifically, the current position and the traveling track). The processing unit 110 may acquire the latest self-vehicle information at this time point. The predicted course 701 of the peripheral vehicle RV may be determined based on the latest peripheral vehicle information (specifically, the current position and the traveling track).

In step S603, the processing unit 110 (for example, the prediction unit 110b thereof) sets a determination region using the predicted intersection 702 as a reference position, and stores the determination region in the storage unit 111. The determination region may be a region where a possibility of collision is predicted. An example of a determination region 703 set using the predicted intersection 702 as a reference position will be described with reference to FIG. 7A. The determination region 703 may be a rectangle including the predicted intersection 702 and a side parallel to the predicted course 700 of the self-vehicle 100. Alternatively, the determination region 703 may have another shape. The position of the determination region 703 with respect to the predicted intersection 702 and the shape thereof may be set in advance (for example, at the time of manufacturing the vehicle 100 or at the time of updating the software) and stored in the storage unit 111. In a case where a risk position exists near the determination region 703, the processing unit 110 may expand the determination region 703 to include the risk position.

The processing unit 110 may set the determination region 703 having a different shape (size) in each of a case where the peripheral vehicle RV is on the right side (that is, a side opposite to the opposite lane side) with respect to the self-vehicle 100 as illustrated in FIG. 7A, and a case where the peripheral vehicle RV is on the left side (that is, the opposite lane side) with respect to the self-vehicle 100 as illustrated in FIG. 7B. A length 704 of the determination region 703 in the vehicle width direction may be the same length (for example, 3 m to 4 m, which is a length corresponding to one lane) regardless of whether the peripheral vehicle RV is on the right side or the left side of the self-vehicle 100. A length 705 of the determination region 703 in the vehicle length direction in a case where the peripheral vehicle RV is on the right side of the self-vehicle 100 may be longer than the length 705 of the determination region 703 in the vehicle length direction in a case where the peripheral vehicle RV is on the left side of the self-vehicle 100. The length 705 of the determination region 703 in the vehicle length direction in a case where the peripheral vehicle RV is on the right side of the self-vehicle 100 may be 9 m to 11 m, which is a length corresponding to three lanes, for example. The length 705 of the determination region 703 in the vehicle length direction in a case where the peripheral vehicle RV is on the left side of the self-vehicle 100 may be 6 m to 8 m, which is a length corresponding to two lanes, for example.

The distance between a side of the determination region 703 far from the self-vehicle 100 and the predicted intersection 702 may be the same (for example, about 1.5 m corresponding to a half lane) regardless of whether the peripheral vehicle RV is on the right side or the left side of the self-vehicle 100. As a result, a length 706 of a part located closer to the self-vehicle 100 than the predicted intersection 702 in the determination region 703 in a case where the peripheral vehicle RV is on the right side of the self-vehicle 100 is longer than a length 706 of a part located closer to the self-vehicle 100 than the predicted intersection 702 in the determination region 703 in a case where the peripheral vehicle RV is on the left side of the self-vehicle 100. In a case where the peripheral vehicle RV is on the right side of the self-vehicle 100, there is a possibility that there is an opposite lane of the lane on which the peripheral vehicle RV is traveling between the predicted intersection 702 and the self-vehicle 100. Therefore, by expanding the determination region 703 toward the self-vehicle 100, it is possible to suppress a collision with another vehicle (which may not have a vehicle-to-vehicle communication function) traveling on this opposite lane.

In step S604, the processing unit 110 (for example, the prediction unit 110b thereof) predicts the possibility of collision between the self-vehicle 100 and the peripheral vehicle RV in the determination region 703. In a case where it is determined that there is a possibility of collision between the self-vehicle 100 and the peripheral vehicle RV, the processing unit 110 shifts the processing to step S605, and shifts the processing to step S607 in other cases.

The possibility of collision may be determined based on a predicted time (hereinafter, simply referred to as the “arrival time”) until the peripheral vehicle RV arrives at the predicted intersection 702. This arrival time may be calculated based on, for example, the latest peripheral vehicle information acquired from the peripheral vehicle RV. For example, the processing unit 110 can predict the predicted time of the peripheral vehicle RV to the predicted intersection 702 by dividing the distance between the peripheral vehicle RV and the predicted intersection 702 by the speed of the peripheral vehicle RV.

The processing unit 110 may predict that there is a possibility of collision in a case where the arrival time is equal to or less than a threshold time, and may determine that there is no possibility of collision in a case where the arrival time is more than the threshold time. The threshold time may be settable by an occupant of the self-vehicle 100.

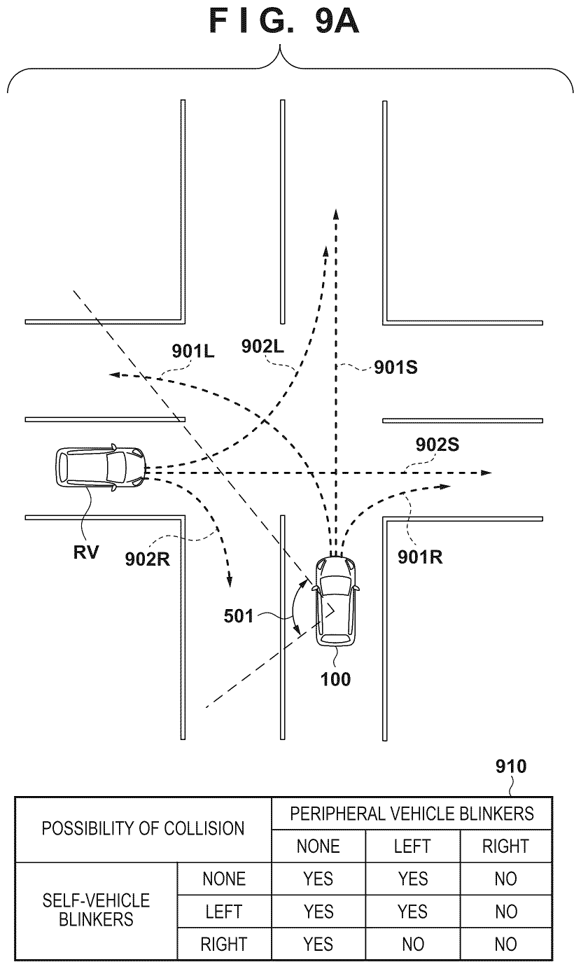

The processing unit 110 may change the threshold time according to the speed of the peripheral vehicle RV. FIG. 8 is a diagram illustrating a relation between the speed of the peripheral vehicle RV and the stop time of the peripheral vehicle RV. The stop time of the peripheral vehicle RV is a time until the peripheral vehicle RV stops at deceleration (for example, 0.4 G) by a typical braking operation. FIG. 8 illustrates a prescribed range (speed upper limit value and speed lower limit value) related to the speed of the peripheral vehicle RV, and a time upper limit value and a time lower limit value related to time to collision (TTC). The prescribed range is a speed range of the peripheral vehicle RV on which driving assistance for the self-vehicle 100 is performed. The time upper limit value is an upper limit value of the time to collision arbitrarily set by the driver or the like, and the time lower limit value is a lower limit value of the time to collision set from the measurement location accuracy of the GNSS.

The processing unit 110 sets the stop time corresponding to the speed of the peripheral vehicle RV as the threshold time based on the “relation between the speed and the stop time of the peripheral vehicle RV” indicated by a line 800 in FIG. 8. The line 800 shows a boundary between a typical braking operation (that is, an operation for decelerating the vehicle in normal times) and an emergency braking operation (that is, an operation for suddenly stopping the vehicle). For example, the line 800 may have a slope corresponding to 0.4 G because the typical braking operation deceleration is 0.4 G or less. In a region 801 above the line 800, the arrival time is longer than the stop time, and if a driver of the peripheral vehicle RV performs the typical braking operation, the peripheral vehicle RV can be stopped before the peripheral vehicle RV arrives at a predicted intersection 702. Therefore, when the arrival time is larger than the threshold time (stop time), driving assistance for the self-vehicle SV can be suppressed. On the other hand, in a region 802 below the line 800, the arrival time is shorter than the stop time, and even if the driver of the peripheral vehicle RV performs the typical braking operation (for example, deceleration of 0.4 G), the peripheral vehicle RV can arrive at the predicted intersection 702 before the peripheral vehicle RV is stopped. Therefore, in a case where the arrival time is equal to or less than the threshold time (stop time), driving assistance of the self-vehicle SV can be performed. Note that the processing unit 110 may change the threshold time continuously or stepwise in accordance with the speed of the peripheral vehicle RV.

The possibility of collision may be determined based on entry of the self-vehicle 100 into the determination region 703 instead of or in addition to the arrival time until the peripheral vehicle RV arrives at the predicted intersection 702. For example, the processing unit 110 may predict that there is a possibility of collision in a case where the self-vehicle 100 has entered the determination region 703, and may determine that there is no possibility of collision in a case where the self-vehicle 100 has not entered the determination region 703.

Furthermore, the possibility of collision may be determined based on the difference (hereinafter, referred to as the “arrival time difference”) between the predicted time until the peripheral vehicle RV arrives at the predicted intersection 702 and the predicted time until the self-vehicle 100 arrives at the predicted intersection 702. The processing unit 110 may predict that there is a possibility of collision in a case where the arrival time difference is equal to or less than the threshold time, and may determine that there is no possibility of collision in a case where the arrival time difference is more than the threshold time. The threshold time may be settable by an occupant of the self-vehicle 100.

Furthermore, the possibility of collision may be predicted based on the indication state of the blinker 107 of the self-vehicle 100, the indication state of the blinker of the peripheral vehicle RV, and the position of the peripheral vehicle RV with respect to the self-vehicle 100. For example, the possibility of collision may be predicted based on at least one of the fact that the peripheral vehicle RV is on the right side or the left side with respect to the self-vehicle 100, the fact that the blinker 107 of the self-vehicle 100 indicates the right side or the left side, and the fact that the blinker of the peripheral vehicle RV indicates the right side or the left side.

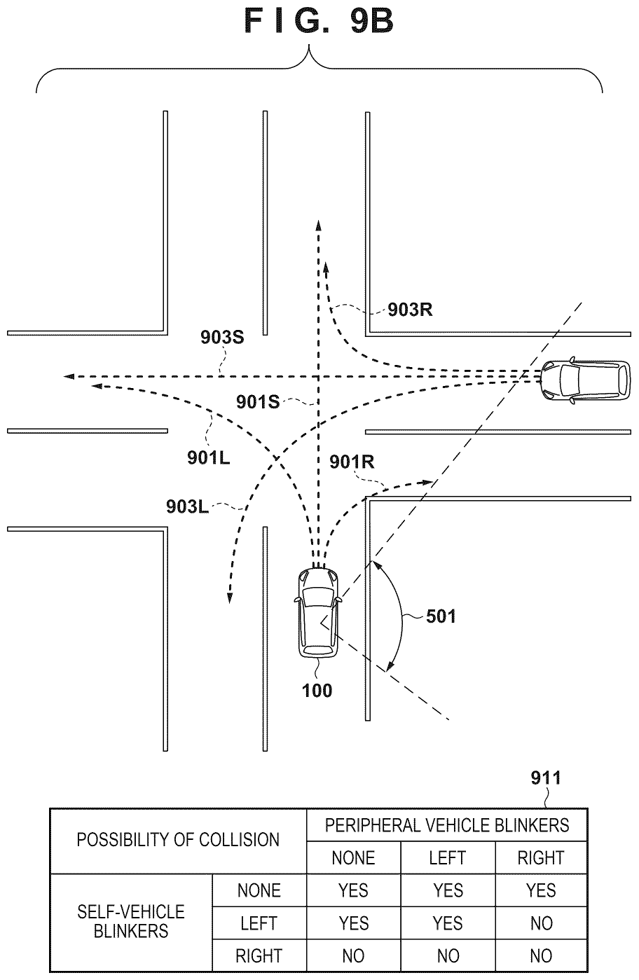

A specific example of prediction of the possibility of collision based on the indication state of the blinker will be described with reference to FIGS. 9A and 9B. FIG. 9A illustrates a case where the peripheral vehicle RV is located within the range 501 on the left side with respect to the self-vehicle 100. When the blinker 107 of the self-vehicle 100 does not indicate a direction (for example, the blinker 107 is turned off), the self-vehicle 100 is expected to take a course 901S traveling straight at an intersection ahead of the self-vehicle 100. When the blinker 107 of the self-vehicle 100 indicates the right side (for example, the blinker 107 on the right side of the self-vehicle 100 is blinking), the self-vehicle 100 is expected to take a course 901R turning right at the intersection ahead of the self-vehicle 100. When the blinker 107 of the self-vehicle 100 indicates the left side (for example, the blinker 107 on the left side of the self-vehicle 100 is blinking), the self-vehicle 100 is expected to take a course 901L turning left at the intersection ahead of the self-vehicle 100.

When the blinker of the peripheral vehicle RV does not indicate a direction, the peripheral vehicle RV is expected to take a course 902S traveling straight through the intersection ahead of the peripheral vehicle RV. When the blinker of the peripheral vehicle RV indicates the right side, the peripheral vehicle RV is expected to take a course 902R turning right at the intersection ahead of the peripheral vehicle RV. When the blinker of the peripheral vehicle RV indicates the left side, the peripheral vehicle RV is expected to take a course 902L turning left at the intersection ahead of the peripheral vehicle RV.

The processing unit 110 may predict that there is a possibility of collision for a pair in which the courses of both the vehicles intersect or coincide with each other among pairs of the three courses 901S, 901R, and 901L predicted for the self-vehicle 100 and the three courses 902S, 902R, and 902L predicted for the peripheral vehicle RV, and predict that there is no possibility of collision for the other pairs. A table 910 in FIG. 9A summarizes the above description. In the table 910, “YES” represents that it is predicted that there is a possibility of collision, and “NO” represents that it is predicted that there is no possibility of collision. The same applies to tables 911 and 1210 described later. For example, when the blinker 107 of the self-vehicle 100 indicates the left side and the blinker of another vehicle indicates the left side, the processing unit 110 may predict that there is a possibility of collision. On the other hand, when the blinker 107 of the self-vehicle 100 indicates the right side and the blinker of another vehicle indicates the right side, the processing unit 110 may predict that there is no possibility of collision.

FIG. 9B illustrates a case where the peripheral vehicle RV is located within the range 501 on the right side with respect to the self-vehicle 100. The courses predicted for the self-vehicle 100 are similar to those in FIG. 9A. When the blinker of the peripheral vehicle RV does not indicate a direction, the peripheral vehicle RV is expected to take a course 903S traveling straight through the intersection ahead of the peripheral vehicle RV. When the blinker of the peripheral vehicle RV indicates the right side, the peripheral vehicle RV is expected to take a course 903R turning right at the intersection ahead of the peripheral vehicle RV. When the blinker of the peripheral vehicle RV indicates the left side, the peripheral vehicle RV is expected to take a course 903L turning left at the intersection ahead of the peripheral vehicle RV.

The processing unit 110 may predict that there is a possibility of collision for a pair in which the courses of both the vehicles intersect or coincide with each other among pairs of the three courses 901S, 901R, and 901L predicted for the self-vehicle 100 and the three courses 903S, 903R, and 903L predicted for the peripheral vehicle RV, and predict that there is no possibility of collision for the other pairs. A table 911 in FIG. 9B summarizes the above description.

The possibility of collision may be determined by arbitrarily combining the above-described four conditions (that is, the arrival time is equal to or less than the threshold time, the self-vehicle 100 has entered the determination region 703, the arrival time difference is equal to or less than another threshold time, and the indication state of the blinker satisfies the above condition). For example, in a case where all of these three conditions are satisfied, the processing unit 110 may determine that there is a possibility of collision, and may determine that there is no possibility of collision in other cases. Alternatively, in a case where at least one of these three conditions is satisfied, the processing unit 110 may determine that there is a possibility of collision, and may determine that there is no possibility of collision in other cases. Alternatively, in a case where at least one of the two preset conditions of these three conditions is satisfied, the processing unit 110 may determine that there is a possibility of collision, and determine that there is no possibility of collision in other cases. Specifically, in a case where the predicted time until the peripheral vehicle RV arrives at the predicted intersection 702 is smaller than a first threshold time, the processing unit 110 may predict that there is a possibility of collision if the arrival time difference is smaller than a second threshold time, and may predict that there is no possibility of collision if the arrival time difference is larger than the second threshold time.

In step S605, the processing unit 110 (for example, the assistance unit 110c thereof) determines whether or not the assistance condition is satisfied. In a case where it is determined that the assistance condition is satisfied, the processing unit 110 shifts the processing to step S606, and shifts the processing to step S607 in other cases. The assistance condition may be a condition to be satisfied in order to perform driving assistance. For example, the assistance condition may be based on whether or not the speed of the peripheral vehicle RV is within a prescribed range. The prescribed range can be set in advance using the speed lower limit value and the speed upper limit value related to the speed of the peripheral vehicle RV. In a case where the speed of the peripheral vehicle RV is equal to or less than the speed lower limit value in the prescribed range, there is a high possibility that the driver of the peripheral vehicle RV notices the self-vehicle 100 and decelerates the peripheral vehicle RV without colliding with the self-vehicle 100. That is, the speed lower limit value in the prescribed range related to the speed of the peripheral vehicle RV can be set to a value that allows the peripheral vehicle RV to be decelerated without colliding with the self-vehicle 100. In addition, in a case where the speed of the peripheral vehicle RV is equal to or larger than the upper limit value of the prescribed range, there is a high possibility that the peripheral vehicle RV is not a vehicle traveling on a road into which the self-vehicle 100 enters, such as traveling on an expressway in the vicinity of the road into which the self-vehicle 100 enters. That is, the upper limit value of the prescribed range related to the speed of the peripheral vehicle RV can be set to a value that enables determination of whether the vehicle is traveling on a road into which the self-vehicle 100 enters or traveling on an expressway in the vicinity of the road. In this manner, the driving assistance is performed/suppressed according to whether or not the speed of the peripheral vehicle RV is within the prescribed range, so that it is possible to reduce annoyance feeling of a driver of the self-vehicle 100 against the driving assistance.

In step S606, the processing unit 110 (for example, the assistance unit 110c thereof) performs driving assistance for the self-vehicle 100. As driving assistance for the self-vehicle 100, the processing unit 110 can notify an occupant of the self-vehicle 100 of the possibility of collision by the notification device 105, and perform a braking operation of the self-vehicle 100 by the braking device 150.

In step S608, the processing unit 110 (for example, the prediction unit 110b thereof) deletes, from the storage unit 111, the determination region (the determination region stored in step S603) that becomes unnecessary due to performance of the driving assistance. As a result, the capacity of the storage unit 111 is suppressed from being consumed by unnecessary information.

In a case where it is determined in step S604 that there is no possibility of collision or in a case where it is determined in step S605 that the assistance condition is not satisfied, step S607 is performed. In step S607, the processing unit 110 (for example, the prediction unit 110b thereof) determines whether or not the registration of the peripheral vehicle RV to be processed in the method of FIG. 6 has been canceled in step S405 of FIG. 4. In a case where it is determined that the registration of the peripheral vehicle RV has been canceled, the processing unit 110 shifts the processing to step S608, and shifts the processing to step S602 in other cases. In a case where the registration of the peripheral vehicle RV has been canceled, it is considered that the peripheral vehicle RV no longer exists around the self-vehicle 100. Therefore, the processing unit 110 ends the processing without performing driving assistance for the collision with the peripheral vehicle RV. Also in this case, in step S608, the processing unit 110 (for example, the prediction unit 110b thereof) deletes the unnecessary determination region from the storage unit 111.

In a case where it is determined in step S607 that the registration of the peripheral vehicle RV has not been canceled, the processing returns to step S602. In this case, in a case where the predicted course of the self-vehicle 100 still intersects with the predicted course of the peripheral vehicle RV, the determination region is set using the predicted intersection 702 as a reference position in step S603. In a case where a vehicle (the self-vehicle 100 or the peripheral vehicle RV) changes its position in the lane or changes the lane, the position of the predicted intersection 702 can change. Since the peripheral vehicle information is repeatedly acquired, the processing unit 110 can detect such a change in the position of the predicted intersection 702. Therefore, in step S603, the processing unit 110 (for example, the prediction unit 110b thereof) resets a reference position based on the newly acquired peripheral vehicle information, and updates the determination region stored in the storage unit 111 accordingly. As a result, the determination in step S604 is performed based on the updated determination region. In step S603, in a case where the predicted intersection 702 cannot be determined (for example, in a case where the predicted course 700 of the self-vehicle 100 and the predicted course 701 of the peripheral vehicle RV no longer intersect with each other), the most recently determined reference position and determination region may be maintained.

According to the method of FIG. 6, in a case where a plurality of peripheral vehicles exist within the range 501 on the side of the self-vehicle 100, an individual reference position is used for each of the plurality of peripheral vehicles. Specifically, the method of FIG. 6 is performed individually for each of the plurality of peripheral vehicles. As a result, the predicted intersection of the predicted course of the self-vehicle 100 and the predicted course of the peripheral vehicle is also determined for each of the plurality of peripheral vehicles. As a result, for each of the plurality of peripheral vehicles, an individual determination region is set based on the individual reference position. Therefore, the possibility of collision with each of the plurality of peripheral vehicles can be appropriately predicted.

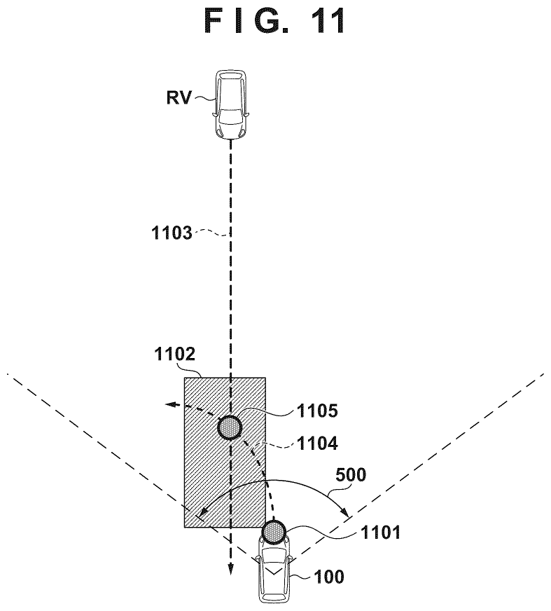

FIG. 10 illustrates an example of processing for performing driving assistance in a case where a peripheral vehicle RV (FIG. 11) exists within the range 500 ahead of the self-vehicle 100. The processing illustrated in the flowchart of FIG. 10 is performed by the processing unit 110 according to the learning program read from the storage unit 111. The processing in FIG. 10 may be started, for example, in response to the setting of the driving assistance being turned on. The processing of FIG. 10 may be repeatedly performed until the setting of the driving assistance is turned off or the ignition of the vehicle 100 is turned off.

In step S1001, the processing unit 110 (for example, the prediction unit 110b thereof) determines whether or not the vehicle speed of the self-vehicle 100 is within a threshold range. The processing unit 110 shifts the processing to step S1002 in a case where it is determined that the vehicle speed of the self-vehicle 100 is within the threshold range, and shifts the processing to step S1003 in other cases. This determination may be made based on the vehicle speed and the acceleration of the self-vehicle 100 included in the latest self-vehicle information. An upper end of the threshold used in step S1001 is a value below the vehicle speed after the vehicle 100 decelerates to turn (for example, left turn or right turn), and may be, for example, 20 km/h. A lower end of the threshold used in step S1001 is a value below the vehicle speed in a state where the vehicle 100 is stopped or substantially stopped, and may be, for example, 2 km/h. The position where the self-vehicle 100 is determined to be within the threshold range is referred to as a turning preparation position 1101 (FIG. 11). Note that the self-vehicle 100 can be within the threshold range even in a case of not turning. Even in this case, the processing unit 110 detects the turning preparation position 1101 and performs the processing of and after step S1002.

In step S1002, the processing unit 110 (for example, the prediction unit 110b thereof) sets a determination region using the turning preparation position 1101 as a reference position, and stores the reference position and the determination region in the storage unit 111. The determination region may be a region where a possibility of collision is predicted. An example of a determination region 1102 set using the turning preparation position 1101 as a reference position will be described with reference to FIG. 11. The determination region 1102 may be a rectangle centered at a position on the left front of the turning preparation position 1101 and including a side parallel to the vehicle length direction of the self-vehicle 100. The length of the determination region 1102 in the vehicle width direction of the self-vehicle 100 may be, for example, 3 m to 4 m, which is a length corresponding to one lane. The length of the determination region 1102 in the vehicle length direction of the self-vehicle 100 may be, for example, 9 m to 11 m, which is a length corresponding to three lanes. The lower right corner of the determination region 1102 may overlap the turning preparation position 1101. Alternatively, the determination region 1102 may have another shape. The position of the determination region 1102 with respect to the reference position may be set in advance (for example, at the time of manufacturing the vehicle 100 or at the time of updating the software) and stored in the storage unit 111. In a case where a risk position exists near the determination region 1102, the processing unit 110 may expand the determination region 1102 to include the risk position. The processing unit 110 sets the determination region 1102 to include the turning preparation position 1101 (that is, the reference position) and to be offset to the opposite lane side (the left side in the example of FIG. 11) with respect to the self-vehicle 100 in the direction orthogonal to the predicted course of the self-vehicle 100. This makes it possible to appropriately predict the possibility of the collision that may occur when the self-vehicle 100 turns left.

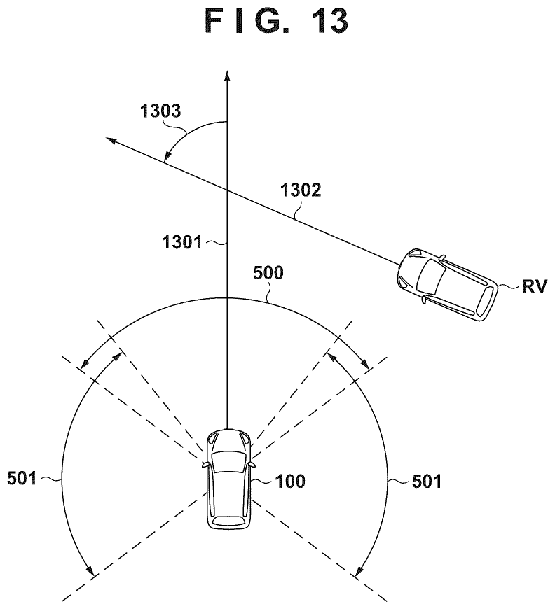

Processing of and after step S1003 is executed using the reference position and the determination region set in step S1002. As described above, since the method of FIG. 13 is repeatedly executed, steps S1001 and S1002 are also repeatedly executed. Therefore, the reference position and the determination region are continuously updated while the vehicle speed of the self-vehicle 100 is within the threshold range (for example, 2 km/h or more and less than 20 km/h), and the processing of and after step S1003 is executed using the latest reference position and determination region. The update of the reference position and the determination region is stopped in response to the vehicle speed of the self-vehicle 100 being outside the threshold range (for example, less than 2 km/h or 20 km/h or more), and the processing of and after step S1003 is executed using the reference position and the determination region when the update is stopped. When the reference position and the determination region are not set at the time of execution of step S1003, the processing unit 110 may omit steps S1003 to S1010 and return the processing to step S1001.

In step S1003, the processing unit 110 (for example, the prediction unit 110b thereof) determines a predicted turning track 1104 of the self-vehicle 100. The predicted turning track 1104 may be a turning track predicted when the self-vehicle 100 turns (for example, left turn) to the opposite lane side. The predicted turning track 1104 may be set in advance (for example, at the time of manufacturing the vehicle 100 or at the time of updating the software) and stored in the storage unit 111. The predicted turning track 1104 set in advance as described above may be referred to as a default predicted turning track 1104.

A plurality of candidates of the predicted turning track 1104 may be stored in the storage unit 111. The processing unit 110 (for example, the prediction unit 110b thereof) may select one predicted turning track 1104 from the plurality of candidates of the predicted turning track 1104 based on the steering angle of the self-vehicle 100 at the turning preparation position 1101 and use the selected predicted turning track 1104 for subsequent processing. For example, in a case where the steering angle of the self-vehicle 100 is small, it is considered that the self-vehicle 100 is about to turn left at a small intersection, so that the processing unit 110 may select the predicted turning track 1104 having a small curvature radius. On the other hand, in a case where the steering angle of the self-vehicle 100 is large, it is considered that the self-vehicle 100 is about to turn left at a large intersection, so that the processing unit 110 may select the predicted turning track 1104 having a large curvature radius.

In step S1004, the processing unit 110 (for example, the prediction unit 110b thereof) identifies the peripheral vehicle RV existing within the range 500 ahead of the self-vehicle 100 as a target vehicle of the subsequent processing. If no peripheral vehicle RV exists within the range 500, no target vehicle is identified. If a plurality of peripheral vehicles RV exist within the range 500, any of the plurality of peripheral vehicles RV is identified as the target vehicle. This identification may be made based on the current position of the peripheral vehicle RV included in the latest peripheral vehicle information acquired from the peripheral vehicle RV. In the example illustrated in FIG. 11, one peripheral vehicle RV exists within the range 500.

In step S1005, the processing unit 110 (for example, the prediction unit 110b thereof) predicts the possibility of collision between the self-vehicle 100 and the peripheral vehicle RV in the determination region 1102. In a case where it is determined that there is a possibility of collision between the self-vehicle 100 and the peripheral vehicle RV, the processing unit 110 shifts the processing to step S1006, and shifts the processing to step S1008 in other cases.

The possibility of collision may be determined based on the fact that an intersection 1105 between the predicted turning track 1104 determined in step S1003 and a predicted course 1103 of the peripheral vehicle RV is included in the determination region 1102. For example, the processing unit 110 may determine that there is a possibility of collision in a case where the intersection 1105 is included in the determination region 1102, and may determine that there is no possibility of collision in a case where the intersection 1105 is not included in the determination region 1102.

Furthermore, the possibility of collision may be predicted based on the indication state of the blinker 107 of the self-vehicle 100, the indication state of the blinker of the peripheral vehicle RV, and the position of the peripheral vehicle RV with respect to the self-vehicle 100. For example, the possibility of collision may be predicted based on at least one of the fact that the peripheral vehicle RV is on the right side or the left side with respect to the self-vehicle 100, the fact that the blinker 107 of the self-vehicle 100 indicates the right side or the left side, and the fact that the blinker of the peripheral vehicle RV indicates the right side or the left side.

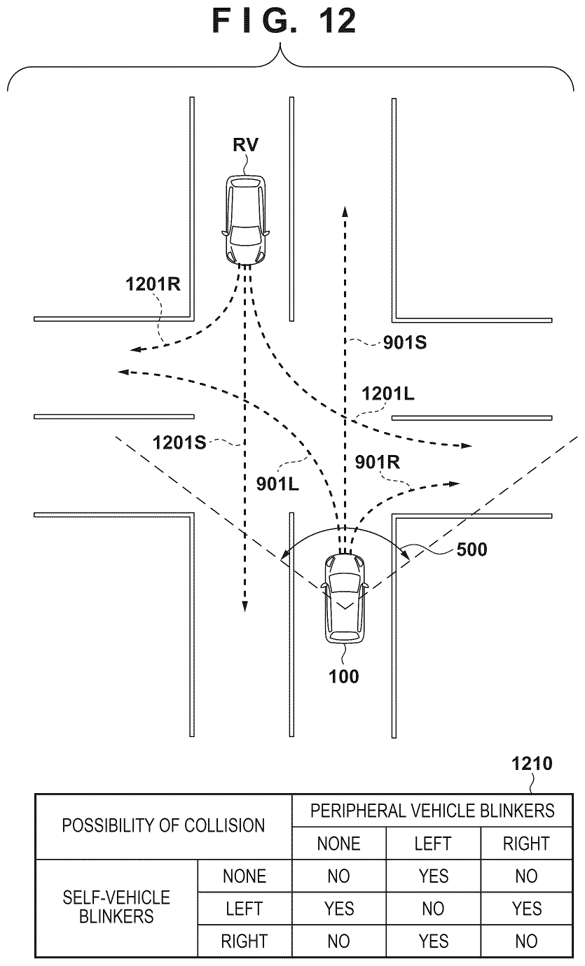

FIG. 12 illustrates a case where the peripheral vehicle RV is located within the range 500 ahead of the self-vehicle 100. The courses predicted for the self-vehicle 100 are similar to those in FIG. 9A. When the blinker of the peripheral vehicle RV does not indicate a direction, the peripheral vehicle RV is expected to take a course 1201S traveling straight through the intersection ahead of the peripheral vehicle RV. When the blinker of the peripheral vehicle RV indicates the right side, the peripheral vehicle RV is expected to take a course 1201R turning right at the intersection ahead of the peripheral vehicle RV. When the blinker of the peripheral vehicle RV indicates the left side, the peripheral vehicle RV is expected to take a course 1201L turning left at the intersection ahead of the peripheral vehicle RV.

The processing unit 110 may predict that there is a possibility of collision for a pair in which the courses of both the vehicles intersect or coincide with each other among pairs of the three courses 901S, 901R, and 901L predicted for the self-vehicle 100 and the three courses 1201S, 1201R, and 1201L predicted for the peripheral vehicle RV, and predict that there is no possibility of collision for the other pairs. A table 1210 in FIG. 12 summarizes the above description.

In step S1006, the processing unit 110 (for example, the assistance unit 110c thereof) determines whether or not the assistance condition is satisfied. In a case where it is determined that the assistance condition is satisfied, the processing unit 110 shifts the processing to step S1007, and shifts the processing to step S1008 in other cases. Since step S1006 may be similar to step S605, redundant description will be omitted.

In step S1007, the processing unit 110 (for example, the assistance unit 110c thereof) performs driving assistance for the self-vehicle 100. As driving assistance for the self-vehicle 100, the processing unit 110 can notify an occupant of the self-vehicle 100 of the possibility of collision by the notification device 105, and perform a braking operation of the self-vehicle 100 by the braking device 150.

In step S1010, the processing unit 110 (for example, the prediction unit 110b thereof) deletes, from the storage unit 111, the reference position and the determination region (the reference position and the determination region stored in step S603) that becomes unnecessary due to performance of the driving assistance. As a result, the capacity of the storage unit 111 is suppressed from being consumed by unnecessary information.

In a case where it is determined in step S1005 that there is no possibility of collision or in a case where it is determined in step S1006 that the assistance condition is not satisfied, step S1008 is performed. In step S1008, the processing unit 110 (for example, the prediction unit 110b thereof) determines whether or not the self-vehicle 100 is separated from the reference position stored in step S1002 by a predetermined distance (for example, 30 m) or more. In a case where it is determined that the self-vehicle 100 is separated from the reference position by the predetermined distance or more, the processing unit 110 shifts the processing to step S1010, and shifts the processing to step S1009 in other cases. In a case where the self-vehicle 100 is separated from the reference position by the predetermined distance or more, it is considered that there is no possibility that the self-vehicle 100 collides with the peripheral vehicle RV at that point. Therefore, the processing unit 110 ends the processing without performing driving assistance for the collision with the peripheral vehicle RV. Also in this case, in step S1010, the processing unit 110 (for example, the prediction unit 110b thereof) deletes the unnecessary reference position and determination region from the storage unit 111.

In a case where it is determined in step S1008 that the self-vehicle 100 is not separated from the reference position by the predetermined distance or more, step S1009 is performed. In step S1009, the processing unit 110 (for example, the prediction unit 110b thereof) may update the predicted turning track 1104 based on the change in the steering angle of the self-vehicle 100. For example, in a case where the self-vehicle 100 turns left at a steering angle larger than that assumed by the predicted turning track 1104, the processing unit 110 may update the predicted turning track 1104 such that the curvature radius decreases. On the other hand, in a case where the self-vehicle 100 turns left at a steering angle smaller than that assumed by the predicted turning track 1104, the processing unit 110 may update the predicted turning track 1104 such that the curvature radius increases. The predicted turning track 1104 may be updated when the current steering angle of the self-vehicle 100 is equal to or larger than the steering angle of the default predicted turning track 1104. Thereafter, the processing unit 110 shifts the processing to step S1004 to identify a peripheral vehicle RV newly included within the range 500 as a target vehicle of the subsequent processing. Further, the possibility of collision in step S1005 is determined based on the updated predicted turning track 1104.

According to the method of FIG. 10, in a case where a plurality of peripheral vehicles exist within the range 500 ahead of the self-vehicle 100, the reference position common to the plurality of peripheral vehicles (that is, the turning preparation position 1101) is used. As a result, for each of the plurality of peripheral vehicles, a common determination region is set based on the common reference position. This makes it possible to appropriately estimate the possibility of collision when the self-vehicle 100 turns to the opposite lane side (for example, when turning left).

According to the above-described embodiment, the possibility of collision can be appropriately predicted according to the position of the peripheral vehicle. As a result, driving assistance for the self-vehicle 100 can be appropriately performed. Note that, even in a state where driving assistance based on peripheral vehicle information acquired from a peripheral vehicle through vehicle-to-vehicle communication is not performed, driving assistance based on other criteria (for example, based on a detection result of a camera or a radar) may be performed.

When predicting the possibility of collision based on the indication state of the blinker described above, the processing unit 110 may determine whether or not the peripheral vehicle RV has performed the lane change based on the traveling track of the peripheral vehicle included in the peripheral vehicle information. When the blinker of the peripheral vehicle RV continues to indicate the direction even after the lane change of the peripheral vehicle RV is completed (for example, when the blinker continues to blink), there is a possibility that the driver of the peripheral vehicle RV has forgotten to turn off the blinker. In this case, the indication state of the blinker of the peripheral vehicle RV does not necessarily coincide with the predicted course of the peripheral vehicle RV. Therefore, when the blinker of the peripheral vehicle RV continues to indicate the direction even after completion of the lane change of the peripheral vehicle RV, the processing unit 110 may predict the possibility of collision not based on the indication state of the blinker of the peripheral vehicle RV. Specifically, as illustrated in FIG. 9B, when the peripheral vehicle RV is located within the range 501 on the right side with respect to the self-vehicle 100 and the blinker of the self-vehicle 100 indicates the right side, the courses of both the vehicles do not intersect or coincide regardless of the direction in which the peripheral vehicle RV travels. Therefore, it may be predicted that there is no possibility of collision. On the other hand, when the peripheral vehicle RV is located within the range 501 on the right side with respect to the self-vehicle 100 and the blinker of the self-vehicle 100 indicates the left side, the courses of both the vehicles intersect or coincide depending on the course of the peripheral vehicle RV. Therefore, the processing unit 110 may predict that there is a possibility of collision in consideration of safety.

The prediction of the possibility of collision described above can be performed using the latest peripheral vehicle information (including the indication state of the blinker) acquired from the peripheral vehicle RV and the latest self-vehicle information (including the indication state of the blinker 107) acquired from the self-vehicle 100. Therefore, the processing unit 110 may notify the occupant of the self-vehicle 100 based on the prediction result of the possibility of collision in the change in which the blinker of the self-vehicle 100 or the peripheral vehicle RV has started the direction indication. As described above, the direction of the blinker can be monitored in real time based on the prediction result of the possibility of collision at the time when the blinker changes the direction indication, and the driver can be notified of the possibility of collision at an early stage. The change of the direction indication by the blinker may be the start of the direction indication by the blinker or the end of the direction indication by the blinker.

In the driving assistance method described above, based on the peripheral vehicle RV being located within the range 500 or 501 of FIG. 5, the peripheral vehicle RV is set as a prediction target of the possibility of collision. Based on other information, the processing unit 110 may determine whether or not the peripheral vehicle RV is set as a prediction target of the possibility of collision. An example of a method of determining the peripheral vehicle RV to be set as a prediction target of the possibility of collision will be described with reference to FIG. 13.

Further, based on a rotation angle 1303 of a course vector 1302 of the peripheral vehicle RV with respect to a course vector 1301 of the self-vehicle 100, the processing unit 110 may determine whether or not the peripheral vehicle RV is set as a prediction target of the possibility of collision. The course vector 1301 may also be a unit vector facing the traveling direction of a vehicle. For the sake of explanation, the rotation angle 1303 is set such that a clockwise direction is positive and a counterclockwise direction is negative.

Even if the peripheral vehicle RV is within the range 500 ahead of the self-vehicle 100, it is considered that there is no possibility of collision between the self-vehicle 100 and the peripheral vehicle RV in a case where the peripheral vehicle RV is traveling in the same direction as the self-vehicle 100 or traveling in the rightward direction or the leftward direction with respect to the self-vehicle 100. Therefore, in a case where the peripheral vehicle RV is within the range 500 ahead of the self-vehicle 100 and the rotation angle 1303 is within a predetermined range (for example, 160° to 200°), the processing unit 110 may set the peripheral vehicle RV as a determination target of the possibility of collision in the processing of FIGS. 6 and 10.

Even if the peripheral vehicle RV is within the range 501 on the right side of the self-vehicle 100, it is considered that there is no possibility of collision between the self-vehicle 100 and the peripheral vehicle RV in a case where the peripheral vehicle RV is traveling in the same direction as or opposite direction to the self-vehicle 100 or traveling in the rightward direction with respect to the self-vehicle 100. Therefore, in a case where the peripheral vehicle RV is within the range 501 on the right side of the self-vehicle 100 and the rotation angle 1303 is within a predetermined range (for example, −110° to −70°), the processing unit 110 may set the peripheral vehicle RV as a determination target of the possibility of collision in the processing of FIGS. 6 and 10.

Even if the peripheral vehicle RV is included in the range 501 on the left side of the self-vehicle 100, it is considered that there is no possibility of collision between the self-vehicle 100 and the peripheral vehicle RV in a case where the peripheral vehicle RV is traveling in the same direction as or opposite direction to the self-vehicle 100 or traveling in the leftward direction with respect to the self-vehicle 100. Therefore, in a case where the peripheral vehicle RV is within the range 501 on the left side of the self-vehicle 100 and the rotation angle 1303 is within a predetermined range (for example, 70° to 110°), the processing unit 110 may set the peripheral vehicle RV as a determination target of the possibility of collision in the processing of FIGS. 6 and 10.

### Summary of Embodiments

### Item 1

A driving assistance device (108) comprising:

an acquisition unit (110a) configured to acquire peripheral vehicle information indicating a vehicle speed, a position, a traveling track, and an indication state of a blinker of a peripheral vehicle (RV) existing around a self-vehicle (100) mounted with the driving assistance device from the peripheral vehicle by vehicle-to-vehicle communication;

a prediction unit (110b) configured to predict a possibility of collision between the self-vehicle and the peripheral vehicle based on self-vehicle information indicating a vehicle speed, a position, a traveling track, and an indication state of a blinker (107) of the self-vehicle and the peripheral vehicle information; and

a notification unit (110c) configured to notify an occupant of the self-vehicle based on a prediction result by the prediction unit, wherein

the prediction unit predicts a possibility of collision between the self-vehicle and the peripheral vehicle based on at least the indication state of the blinker of the self-vehicle, the indication state of the blinker of the peripheral vehicle, and the position of the peripheral vehicle with respect to the self-vehicle.

According to this item, it is possible to accurately acquire the indication state of the blinker of the peripheral vehicle by the vehicle-to-vehicle communication. The possibility of collision between the self-vehicle and the peripheral vehicle can be accurately predicted using the indication state of the blinker. As a result, it is possible to suppress excessive notification to a driver.

### Item 2

The driving assistance device according to item 1, wherein

a first side is one of a right side and a left side which is a side of a road on which passage is mandatory in a region where the self-vehicle is located, and a second side is a side opposite to the first side, and

the prediction unit predicts a possibility of collision between the self-vehicle and the peripheral vehicle based on at least one of
the peripheral vehicle being on the first side or the second side with respect to the self-vehicle,
the blinker of the self-vehicle indicating the first side or the second side, and
the blinker of the peripheral vehicle indicating the first side or the second side.

According to this item, it is possible to suppress excessive notification to the driver in a specific situation.

### Item 3

The driving assistance device according to item 2, wherein

in a case where the peripheral vehicle is located within a first range (501) on the first side or within a second range (501) on the second side with respect to the self-vehicle, the blinker of the self-vehicle indicates the second side, and the blinker of the peripheral vehicle indicates the first side,
the prediction unit predicts that there is no possibility of collision between the self-vehicle and the peripheral vehicle.

According to this item, it is possible to suppress excessive notification to the driver in a specific situation.

### Item 4

The driving assistance device according to item 2 or 3, wherein

in a case where the peripheral vehicle is located within a second range (501) on the second side with respect to the self-vehicle and the blinker of the peripheral vehicle indicates the first side, or

in a case where the peripheral vehicle is located within the second range on the second side with respect to the self-vehicle, the blinker of the self-vehicle indicates the first side, and the blinker of the peripheral vehicle indicates the first side or the second side,
the prediction unit predicts that there is no possibility of collision between the self-vehicle and the peripheral vehicle.

According to this item, it is possible to suppress excessive notification to the driver in a specific situation.

### Item 5

The driving assistance device according to any one of items 2-4, wherein

in a case where the peripheral vehicle is located within a first range (501) on the first side with respect to the self-vehicle and the blinker of the self-vehicle indicates the first side,
the prediction unit predicts that there is no possibility of collision between the self-vehicle and the peripheral vehicle.

According to this item, it is possible to suppress excessive notification to the driver in a specific situation.

### Item 6

The driving assistance device according to any one of items 2-5, wherein in a case where the peripheral vehicle is located within a third range (500) ahead of the self-vehicle, the blinker of the self-vehicle indicates the second side, and the blinker of the peripheral vehicle indicates the second side,
the prediction unit predicts that there is no possibility of collision between the self-vehicle and the peripheral vehicle.

According to this item, it is possible to suppress excessive notification to the driver in a specific situation.

### Item 7

The driving assistance device according to any one of items 2-6, wherein

in a case where the peripheral vehicle is located within a third range (500) ahead of the self-vehicle, the blinker of the self-vehicle does not indicate a direction or indicates the first side, and the blinker of the peripheral vehicle does not indicate a direction or indicates the first side,
the prediction unit predicts that there is no possibility of collision between the self-vehicle and the peripheral vehicle.

According to this item, it is possible to suppress excessive notification to the driver in a specific situation.

### Item 8

The driving assistance device according to any one of items 1-7, wherein

the notification unit notifies the occupant of the self-vehicle based on a prediction result by the prediction unit at a time point when the blinker of the self-vehicle or the peripheral vehicle changes an indication of a direction.

According to this item, the possibility of collision can be predicted at an early stage.

### Item 9

The driving assistance device according to any one of items 1-8, further comprising a determination unit configured to determine whether or not the peripheral vehicle has performed a lane change based on a traveling track of the peripheral vehicle included in the peripheral vehicle information, wherein

in a case where the blinker of the peripheral vehicle continuously indicates a direction even after completion of a lane change of the peripheral vehicle, the prediction unit predicts a possibility of collision between the self-vehicle and the peripheral vehicle not based on the indication state of the blinker of the peripheral vehicle.

According to this item, it is possible to provide appropriate driving assistance even when the driver forgets to turn off the blinker after the lane change.

### Item 10

The driving assistance device according to item 3, wherein

the first range is a fan-shaped range located on the first side with respect to the self-vehicle and defined by a predetermined distance and a predetermined angle, and

the second range is a fan-shaped range located on the second side with respect to the self-vehicle and defined by a predetermined distance and a predetermined angle.

According to this item, a peripheral vehicle within an appropriate range can be set as a prediction target of the possibility of collision.

### Item 11

The driving assistance device according to item 6 or 7, wherein

the third range is a fan-shaped range located ahead of the self-vehicle and defined by a predetermined distance and a predetermined angle.

According to this item, a peripheral vehicle within an appropriate range can be set as a prediction target of the possibility of collision.

### Item 12

A driving assistance method comprising:

acquiring (S403) peripheral vehicle information indicating a vehicle speed, a position, a traveling track, and an indication state of a blinker of a peripheral vehicle (RV) existing around a self-vehicle (100) from the peripheral vehicle by vehicle-to-vehicle communication;

predicting (S604, S1005) a possibility of collision between the self-vehicle and the peripheral vehicle based on self-vehicle information indicating a vehicle speed, a position, a traveling track, and an indication state of a blinker of the self-vehicle and the peripheral vehicle information; and

notifying (S606, S1007) an occupant of the self-vehicle based on a prediction result in the predicting, wherein

the predicting including predicting a possibility of collision between the self-vehicle and the peripheral vehicle based on at least the indication state of the blinker of the self-vehicle, the indication state of the blinker of the peripheral vehicle, and the position of the peripheral vehicle with respect to the self-vehicle.

According to this item, it is possible to suppress excessive notification to the driver.

### Item 13

A non-transitory computer readable storage medium storing a program for causing a computer to execute:

acquiring (S403) peripheral vehicle information indicating a vehicle speed, a position, a traveling track, and an indication state of a blinker of a peripheral vehicle (RV) existing around a self-vehicle (100) from the peripheral vehicle by vehicle-to-vehicle communication;

predicting (S604, S1005) a possibility of collision between the self-vehicle and the peripheral vehicle based on self-vehicle information indicating a vehicle speed, a position, a traveling track, and an indication state of a blinker of the self-vehicle and the peripheral vehicle information; and

notifying (S606, S1007) an occupant of the self-vehicle based on a prediction result in the predicting, wherein

the predicting includes predicting a possibility of collision between the self-vehicle and the peripheral vehicle based on at least the indication state of the blinker of the self-vehicle, the indication state of the blinker of the peripheral vehicle, and the position of the peripheral vehicle with respect to the self-vehicle.

According to this item, it is possible to suppress excessive notification to the driver.

The invention is not limited to the foregoing embodiments, and various variations/changes are possible within the spirit of the invention.

What is claimed is:

1. A driving assistance device comprising:
an acquisition unit configured to acquire peripheral vehicle information indicating a vehicle speed, a position, a traveling track, and an indication state of a blinker of a peripheral vehicle existing around a self-vehicle mounted with the driving assistance device from the peripheral vehicle by vehicle-to-vehicle communication;
a prediction unit configured to predict a possibility of collision between the self-vehicle and the peripheral vehicle based on self-vehicle information indicating a vehicle speed, a position, a traveling track, and an indication state of a blinker of the self-vehicle and the peripheral vehicle information; and
a notification unit configured to notify an occupant of the self-vehicle based on a prediction result by the prediction unit, wherein
the prediction unit predicts a possibility of collision between the self-vehicle and the peripheral vehicle based on at least the indication state of the blinker of the self-vehicle, the indication state of the blinker of the peripheral vehicle, and the position of the peripheral vehicle with respect to the self-vehicle.

2. The driving assistance device according to claim 1, wherein
a first side is one of a right side and a left side which is a side of a road on which passage is mandatory in a region where the self-vehicle is located, and a second side is a side opposite to the first side, and
the prediction unit predicts a possibility of collision between the self-vehicle and the peripheral vehicle based on at least one of
the peripheral vehicle being on the first side or the second side with respect to the self-vehicle,
the blinker of the self-vehicle indicating the first side or the second side, and
the blinker of the peripheral vehicle indicating the first side or the second side.

3. The driving assistance device according to claim 2, wherein
in a case where the peripheral vehicle is located within a first range on the first side or within a second range on the second side with respect to the self-vehicle, the blinker of the self-vehicle indicates the second side, and the blinker of the peripheral vehicle indicates the first side,
the prediction unit predicts that there is no possibility of collision between the self-vehicle and the peripheral vehicle.

4. The driving assistance device according to claim 2, wherein
in a case where the peripheral vehicle is located within a second range on the second side with respect to the self-vehicle and the blinker of the peripheral vehicle indicates the first side, or
in a case where the peripheral vehicle is located within the second range on the second side with respect to the self-vehicle, the blinker of the self-vehicle indicates the first side, and the blinker of the peripheral vehicle indicates the first side or the second side,
the prediction unit predicts that there is no possibility of collision between the self-vehicle and the peripheral vehicle.

5. The driving assistance device according to claim 2, wherein
in a case where the peripheral vehicle is located within a first range on the first side with respect to the self-vehicle and the blinker of the self-vehicle indicates the first side,
the prediction unit predicts that there is no possibility of collision between the self-vehicle and the peripheral vehicle.

6. The driving assistance device according to claim 2, wherein
in a case where the peripheral vehicle is located within a third range ahead of the self-vehicle, the blinker of the self-vehicle indicates the second side, and the blinker of the peripheral vehicle indicates the second side,
the prediction unit predicts that there is no possibility of collision between the self-vehicle and the peripheral vehicle.

7. The driving assistance device according to claim 2, wherein
in a case where the peripheral vehicle is located within a third range ahead of the self-vehicle, the blinker of the self-vehicle does not indicate a direction or indicates the first side, and the blinker of the peripheral vehicle does not indicate a direction or indicates the first side,
the prediction unit predicts that there is no possibility of collision between the self-vehicle and the peripheral vehicle.

8. The driving assistance device according to claim 1, wherein
the notification unit notifies the occupant of the self-vehicle based on a prediction result by the prediction unit at a time point when the blinker of the self-vehicle or the peripheral vehicle changes an indication of a direction.

9. The driving assistance device according to claim 1, further comprising a determination unit configured to determine whether or not the peripheral vehicle has performed a lane change based on a traveling track of the peripheral vehicle included in the peripheral vehicle information, wherein
in a case where the blinker of the peripheral vehicle continuously indicates a direction even after completion of a lane change of the peripheral vehicle, the prediction unit predicts a possibility of collision between the self-vehicle and the peripheral vehicle not based on the indication state of the blinker of the peripheral vehicle.

10. The driving assistance device according to claim 3, wherein
the first range is a fan-shaped range located on the first side with respect to the self-vehicle and defined by a predetermined distance and a predetermined angle, and
the second range is a fan-shaped range located on the second side with respect to the self-vehicle and defined by a predetermined distance and a predetermined angle.

11. The driving assistance device according to claim 6, wherein
the third range is a fan-shaped range located ahead of the self-vehicle and defined by a predetermined distance and a predetermined angle.

12. A driving assistance method comprising:
acquiring peripheral vehicle information indicating a vehicle speed, a position, a traveling track, and an indication state of a blinker of a peripheral vehicle existing around a self-vehicle from the peripheral vehicle by vehicle-to-vehicle communication;
predicting a possibility of collision between the self-vehicle and the peripheral vehicle based on self-vehicle information indicating a vehicle speed, a position, a traveling track, and an indication state of a blinker of the self-vehicle and the peripheral vehicle information; and
notifying an occupant of the self-vehicle based on a prediction result in the predicting, wherein
the predicting including predicting a possibility of collision between the self-vehicle and the peripheral vehicle based on at least the indication state of the blinker of the self-vehicle, the indication state of the blinker of the peripheral vehicle, and the position of the peripheral vehicle with respect to the self-vehicle.

13. A non-transitory computer readable storage medium storing a program for causing a computer to execute:
acquiring peripheral vehicle information indicating a vehicle speed, a position, a traveling track, and an indication state of a blinker of a peripheral vehicle existing around a self-vehicle from the peripheral vehicle by vehicle-to-vehicle communication;
predicting a possibility of collision between the self-vehicle and the peripheral vehicle based on self-vehicle information indicating a vehicle speed, a position, a traveling track, and an indication state of a blinker of the self-vehicle and the peripheral vehicle information; and
notifying an occupant of the self-vehicle based on a prediction result in the predicting, wherein
the predicting includes predicting a possibility of collision between the self-vehicle and the peripheral vehicle based on at least the indication state of the blinker of the self-vehicle, the indication state of the blinker of the peripheral vehicle, and the position of the peripheral vehicle with respect to the self-vehicle.
